(19) United States
(12) Patent Application Publication
(10) Pub. No.: US 2008/0211245 A1
(43) Pub. Date: Sep. 4, 2008

(54) Sport bike tow sling II

(75) Inventor: Lewis Wayne Harden, Corpus Christi, TX (US)

Correspondence Address: Lewis Wayne Harden II, POB 454, Montgomery, TX, 77356, US

(73) Assignee: Lewis Wayne Harden, Corpus Christi, TX (US)

(21) Appl. No.: 11/714,014

(22) Filed: Mar. 3, 2007

(51) Int. Cl. B66C 1/12

(52) U.S. Cl. 294/74

(57) ABSTRACT

A sling is disclosed for use on a conventional tow truck to facilitate and minimize damage in towing a motorcycle, with a preferred application for towing a sport bike. The sling comprises a single-component lifting brace (5) that is placed under the seat of the motorcycle. It also comprises at least two straps (13 and 15) to permit lifting the motorcycle on the tow truck wheel-lift assembly. A heat resistant pad is optionally used between the brace and the motorcycle or between a strap and the motorcycle to further limit damage potential from using the sling.

### FIELD OF INVENTION

In the field of commercial tow trucks, a tow sling for loading and unloading motorcycles for carriage to another location.

### DESCRIPTION OF PRIOR ART

Motorcycle carriage by commercial tow trucks, also known as wreckers, is commonly performed, especially for sport bikes, using two, 2-in. wide nylon straps. The straps are threaded around the frame of the motorcycle, typically one seat under steering head where the steering wheel meets the frame and one around the seat. The ends of the straps are attached to the power hook on the boom of the wrecker and the motorcycle is then lifted off the ground. The motorcycle is supported at the top by the boom. At the bottom, the motorcycle wheels are secured to the wheel-lift on the wrecker, which prevents unwieldy movement of the motorcycle in transit. Safety chains are also used to secure the motorcycle.

A problem with the above method arises, especially for modern high performance motorcycles, or sport bikes, which are outfitted with fragile components, typically made of fiberglass, in the region where the nylon strap wraps around the seat of the motorcycle. The stress on these components caused by the weight of the motorcycle transferred to them by the nylon strap can easily cause significant damage. This damage can be costly when it occurs, and gives rise to customer dissatisfaction, insurance claims, higher insurance premiums and lost productivity in the towing industry.

One solution to this problem that has been proposed is to use a rack for the motorcycle. The rack is assembled at the tow site, the motorcycle is rolled onto the rack and secured in place, and then the wheel-lift on the tow truck raises the rack and motorcycle off the ground for transport. United States Patent Application 20040076498 by Thompson, et al., filed Apr. 22, 2004, is for such a rack system for securing a motorcycle. The Thompson invention is more complicated than the present invention. It has more parts, requires time-consuming assembly, and is a heavier and more cumbersome device than present invention.

Other solutions involve mechanisms for lifting and securing one wheel of the motorcycle in a cradle and having the other wheel in contact with the ground. Examples of these solutions are U.S. Pat. No. 5,145,308 to Vaughn, et al. on Sep. 8, 1992, and U.S. Pat. No. 6,682,292 to Estes on Jan. 27, 2004. Neither of these solutions is satisfactory because each requires one wheel of the motorcycle to roll on the ground. Additionally, these mechanisms suffer from the same deficiencies as the Thompson invention described above.

Accordingly, the present invention will serve to improve the prior art by providing a motorcycle tow sling for a commercial tow truck that prevents damage to fragile motorcycle components by eliminating contact between a nylon lifting strap and the fragile components around a motorcycle seat. The present invention takes up minimal space on the tow truck, enables a tow truck operator to offer specialized service for improved customer satisfaction, and significantly reduces the potential for damage claims, and increases speed and thus productivity in providing towing services for motorcycles.

### BRIEF SUMMARY OF THE INVENTION

A sling is disclosed for use on a conventional tow truck to facilitate and minimize damage in towing a motorcycle, with a preferred application for towing a sport bike. The sling comprises a single component lifting brace that is placed under the seat of the motorcycle and at least two straps to permit lifting the motorcycle on the tow truck wheel-lift assembly. A heat resistant pad is optionally used between the brace and the motorcycle or between the strap and the motorcycle to further limit damage potential from the use of the sling.

### BRIEF DESCRIPTION OF THE DRAWINGS

Referring now to the drawings in which like reference numbers represent corresponding parts throughout. The drawings represent the preferred embodiment of elements of the invention.

FIG. 1 is a perspective of the brace.

FIG. 2 is a side view of two straps.

FIG. 3 is a side view of the brace and straps in the context of a motorcycle.

### DETAILED DESCRIPTION

In the following description, reference is made to the accompanying drawings, which form a part hereof and which illustrate a preferred embodiment of the present invention. The drawings and the preferred embodiment of the invention are presented with the understanding that the present invention is susceptible of embodiments in many different forms and, therefore, other embodiments may be utilized and structural and operational changes may be made without departing from the scope of the present invention.

The drawings illustrate a sling for a tow truck to enable carriage of a motorcycle, preferably the kind of motorcycle known in the art as a sport bike. The sling first has a brace capable of supporting the weight of the motorcycle.

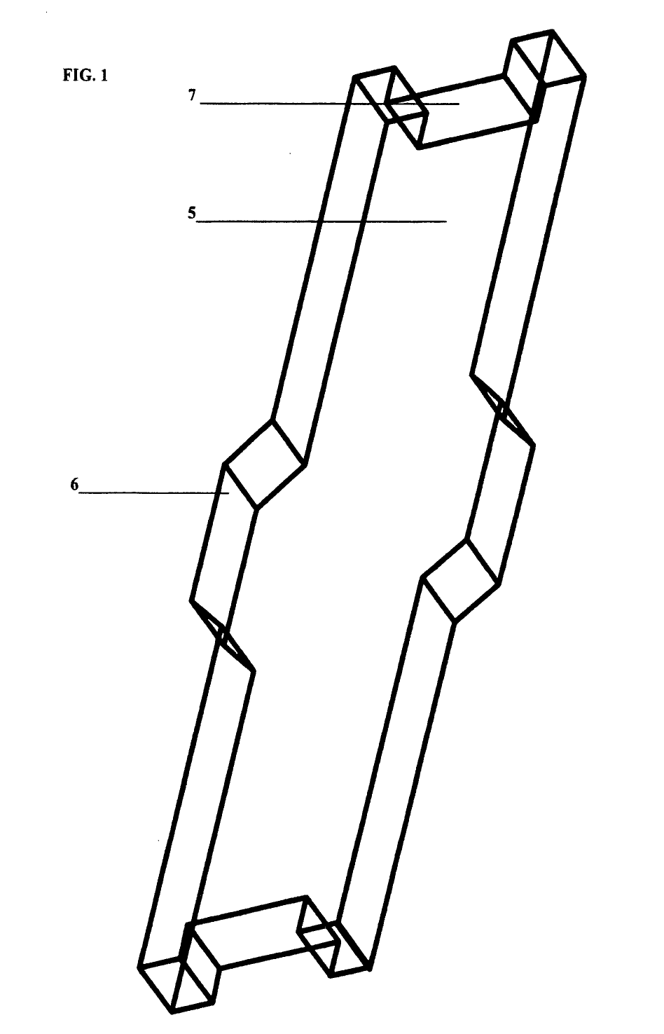

FIG. 1 illustrates the preferred embodiment of the brace (5). The brace (5) may be made of any sturdy material, such as metal or plastic, capable of supporting the weight of a typical motorcycle. As shown, the brace is principally made from a single component preferably rectangle-shaped component. (6) Shows protruding sides, to keep brace from rolling over. (7) Shows indentions on the ends. Each indention (7) is used to guide and hold in place on the brace a lifting strap.

The preferred embodiment of the sling includes at least two straps each capable of supporting the weight of the motorcycle at least one of which fits within two indentions (7) on the brace.

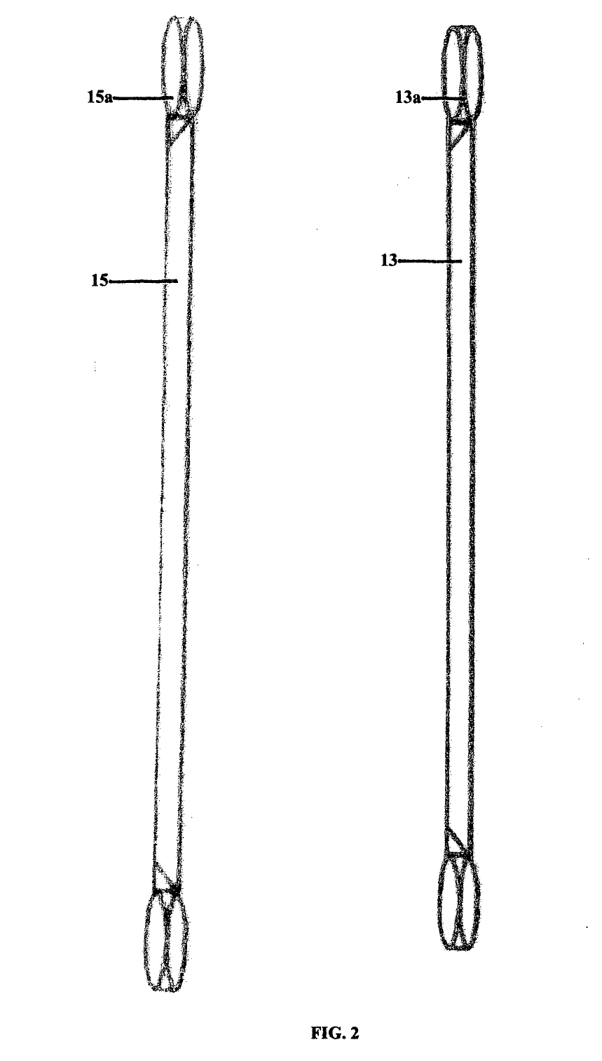

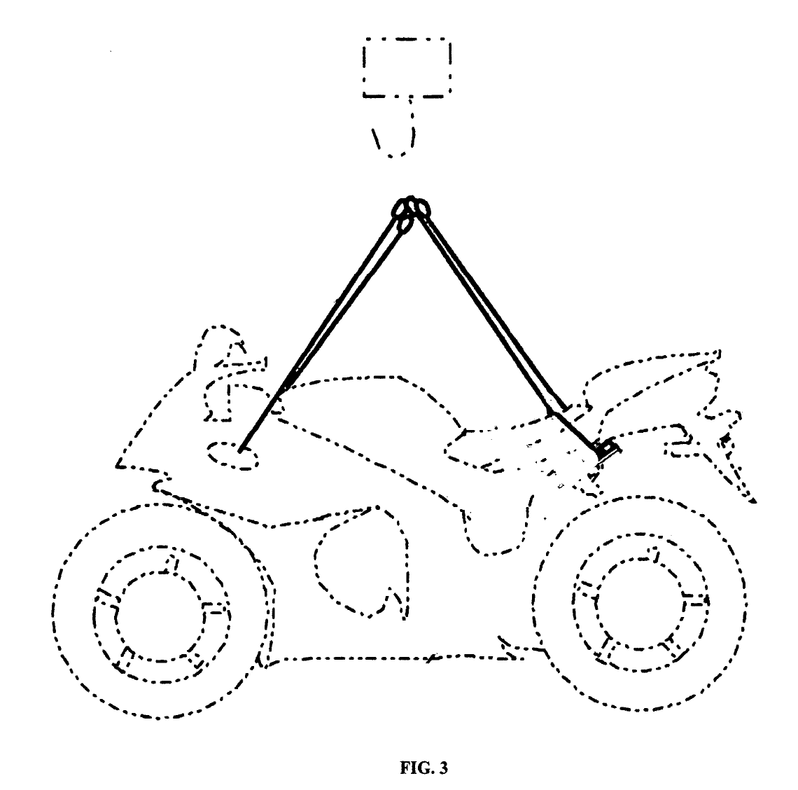

FIG. 2 shows the configuration of two preferred straps, a brace lifting strap (13) and a fork lifting strap (15). Both straps have loops (13a and 15a) at their ends to facilitate use on a hook typically found at the end of a boom on a wrecker. Use of both straps is illustrated in FIG. 3. The preferred straps are those typically used in the towing industry made of woven nylon about 2 inches in width. It is intended that the term “strap” as used herein denotes any type of rope or length of material capable of being used to lift a motorcycle.

Alternative embodiments of the invention also include a pad for use to help avoid damage to the motorcycle and distribute the forces acting upon the motorcycle from the brace or any strap. In use, the pad is deployed intermediate to the brace and motorcycle or between a strap and a motorcycle. The pad may optionally be made with a heat resistant outer covering so that when the sling is used on a motorcycle with an under-seat exhaust system, the components of the sling are also protected from the heat.

Alternative embodiments of the invention employ a rubberized or other elastic coating over the surface of the brace. This coating protects the brace and the motorcycle from damage.

Alternative embodiments have reflective tape around edges of the brace so it can be seen at night.

Alternative embodiments of the invention include ties to secure the wheels of the motorcycle to the wrecker for carriage. These are typical of what is found in the industry for this purpose.

The disclosure herein is to be considered as an exemplification of the principles of the invention and is not intended to limit the broad aspect of the invention to the embodiments illustrated. Thus, the scope of the invention is determined by the appended claims and their legal equivalents rather than by the examples given.

What is claimed is:

1. A sling for a tow truck to enable carriage of a motorcycle comprising,
(a) A brace capable of supporting the weight of the motorcycle, said brace comprising a single component that can be placed under the seat of a motorcycle behind the rear seat pegs on the motorcycle and extend beyond the frame of the motorcycle and wherein said brace has an indention on each end to guide straps used for lifting; and,
(b) A plurality of straps each capable of supporting the weight of the motorcycle at least one of which fits within a plurality of indentions on the brace.

2. The sling of claim 1 further comprising a pad usable between the brace and motorcycle or between a strap and the motorcycle to distribute the forces from a brace or strap acting on the motorcycle.

3. The sling of claim 2 wherein the pad has a heat resistant outer covering.

4. The sling of claim 1 wherein at least one strap that is capable of spanning the brace and fitting in the indentions.

5. The sling of claim 1 the straps have loops at their ends to facilitate use with a hook.

6. The sling of claim 1 further comprising ties to secure the wheels of the motorcycle to the wrecker for carriage.

7. The sling of claim 1 also has reflective tape around edges of brace.
